(19) United States
(12) Patent Application Publication
(10) Pub. No.: US 2024/0418496 A1
(43) Pub. Date: Dec. 19, 2024

(54) Optical Encoder Emulation Using Hall Effect Sensor

(71) Applicant: Power Engineering & Mfg., Inc., Blaine, MN (US)

(72) Inventors: James L BLESENER, Blaine, MN (US); Amir Hooshang AMIGHI, Blaine, MN (US)

(73) Assignee: Power Engineering & Mfg., Inc., Blaine, MN (US)

(21) Appl. No.: 18/818,378

(22) Filed: Aug. 28, 2024

Related U.S. Application Data
(63) Continuation of application No. 17/727,598, filed on Apr. 22, 2022, now abandoned.
(60) Provisional application No. 63/179,030, filed on Apr. 23, 2021.

(51) Int. Cl. G01B 7/30; F16H 1/20; F16H 57/02; H02K 11/215; H02K 11/22

(52) U.S. Cl. CPC G01B 7/30; F16H 1/20; F16H 57/02; H02K 11/215; H02K 11/22; F16H 2057/02034

(57) ABSTRACT

A rotary actuator including a motor, gears, and a sensor connected to an output shaft. Electronics is communicatively connected to monitor sensor position and output a simulated optical encoder response. An actuator has a base; a motor coupled to the base; a transmission communicatively connected to the motor to transmit rotary power from the motor; an output shaft communicatively connected to the transmission, the output shaft being adapted or configured to be connected to an article or apparatus to be actuated; and a magnetic, non-contact sensor communicatively connected to the output shaft whereby the sensor measures output shaft position with calibration

### CROSS-REFERENCE TO RELATED APPLICATIONS, IF ANY

This application claims the benefit under 35 U.S.C. § 119 (e) of co-pending U.S. Provisional Patent Application Ser. No. 63/790,030, filed Apr. 23, 2021, which is hereby incorporated by reference.

### 37 C.F.R. § 1.71 (e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND

### 1. Field

The present invention relates, generally, to electro-mechanical devices. More particularly, the invention relates to electro-mechanical actuators. Most particularly, the invention relates to an improved rotary gear actuator.

### 2. Background Information

Applicant has designed and manufactured standard rotary gear motor actuators for many years. Such actuators have a gear motor with an output shaft. An optical encoder may be added to designate a home position. In one application of the actuator, a controller looks at the encoder output and then a simple motor controller runs the gear motor to a specific position. This is a standard in some industries.

FIG. 22 is a diagram of a prior art automotive steering/throttle sensor, for example, as provided by Infineon. Such a device has certain safety and thermal limits. In normal operation, a magnet is placed above a sensor and as it rotates one receives a signal out defining where the N-S field of the magnet is or 0-359.9 degrees.

Some limitations with this standard exist, including:
1) The optical encoder has a limited thermal range.
2) The optical encoder has limited internal protection for ESD, over voltage and electrical noise.
3 The optical encoder has problems with moisture, grease and other vapors.
4) The optical encoder has an absolute home position requiring a system calibration during assembly to set the home position so the final controller knows where home is located.
5) High Cost.

Applicant investigated these limitations and concluded that an optical encoder could be advantageous. Applicant developed the following product goals:
1) Automotive quality components using 150 C thermal limits.
2) Noncontact sensor.
3) Sensor linearity is not an issue as applicant can calibrate each product on the production line.
4) Sensor linear stability over temperature and time is important.
5) The system cost of the encoder replacement would need to be less then the encoder.
6) The life of the encoder emulation should be indefinite-no limiting life failure modes.
7) The encoder emulation should run on the standard power of an optical encoder.

For these and other reasons, a need exists for the present invention.

All US patents and patent applications, and all other published documents mentioned anywhere in this application are hereby incorporated by reference in their entirety.

### BRIEF SUMMARY

The present invention provides an actuator apparatus and method which are practical, reliable, accurate and efficient, and which are believed to fulfill a need and to constitute an improvement over the background technology.

In one aspect, the invention provides an emulated optical encoder using a noncontact magnetic sensor to measure output position with calibration to improve accuracy and electronics to simulate encoder outputs used to measure rotary position of a shaft.

In another aspect, the invention provides an actuator, comprising
a base;
a motor coupled to the base;
a transmission communicatively connected to the motor to transmit rotary power from the motor;
an output shaft communicatively connected to the transmission, the output shaft being adapted or configured to be connected to an article or apparatus to be actuated; and
a magnetic, non-contact sensor communicatively connected to the output shaft whereby the sensor measures output shaft position with calibration.

In a further aspect, the invention provides an actuator, comprising
a. a housing having an internal enclosure;
b. an electric DC stepper motor coupled to and disposed in the housing, the motor having an output shaft with a rotary motor gear connected to the output shaft;
c. a transmission communicatively connected to the motor to transmit rotary power from the motor, the transmission having at least one gear stage including a shaft assembly and a gear connected to the shaft assembly; the gear being communicatively connected to the motor gear;
d. an output shaft communicatively connected to the transmission, the output shaft being adapted to be connected to an article to be actuated, the output shaft including an output gear communicatively connected to the at least one gear stage gear;
e. a magnetic, non-contact sensor communicatively connected to the output shaft whereby the sensor measures output shaft position with calibration; and
f. a control circuit communicatively connected to the sensor to simulate encoder output to measure rotary shaft position.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

The present invention, and the manner and process of making and using it, will be better understood by those skilled in the art by reference to the following drawings.

FIG. 1 is a perspective view of an embodiment of an actuator of the prevent invention, from the output end thereof.

FIG. 2 is top view of the actuator.

FIG. 3 is elevation view of the actuator from a first side thereof.

FIG. 4 is an elevation view of the actuator from a first, or distal end thereof,

FIG. 5 is an elevation view of the actuator from the second or proximal end thereof.

FIG. 6 is a first exploded view of the actuator, taken from the distal end thereof.

FIG. 7 is second exploded view of the actuator, taken from the proximal end thereof.

FIG. 8 is an elevation view of the actuator, taken with a distal housing member removed, showing internal components thereof.

FIG. 9 is a third exploded view of the actuator, again taken from the distal end thereof, and wherein certain internal components thereof have been separated from the housing elements.

FIG. 10 is a substantially fully exploded view of the actuator.

FIG. 11 is a longitudinal crossectional view of the actuator taken along line 11-11 of FIG. 4.

FIG. 12 is a longitudinal crossectional view of the actuator taken along line 12-12 of FIG. 4.

FIG. 13 is a lateral crossectional view of the actuator taken along line 13-13 of FIG. 11.

FIG. 14 is longitudinal crossectional view of the actuator taken along line 14-14 of FIG. 15.

FIG. 15 is an elevation view, partially in crossection of the distal end of the actuator.

FIG. 16 is a schematic diagram of an embodiment of a power supply circuit of the invention for the actuator of the invention.

FIG. 17 is a schematic diagram of an embodiment of an encoder circuit of the invention.

FIG. 18 is a schematic diagram of an embodiment of angle sensor and circuit for measuring shaft angle and calibration of the invention.

FIG. 19 is a diagram showing a simulated optical encoder response.

FIG. 20 is a graph showing angle sensor error, where the X axis indicates Degrees and the Y axis shows Degrees Error.

FIG. 21 is a graph showing sensor linearization, where the X axis designates and the Y axis shows Sensor Degrees.

FIG. 22 is a diagram of a prior art automotive steering/throttle sensor.

### DETAILED DESCRIPTION

The description that follows describes, illustrates and exemplifies one or more embodiments of the present invention. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

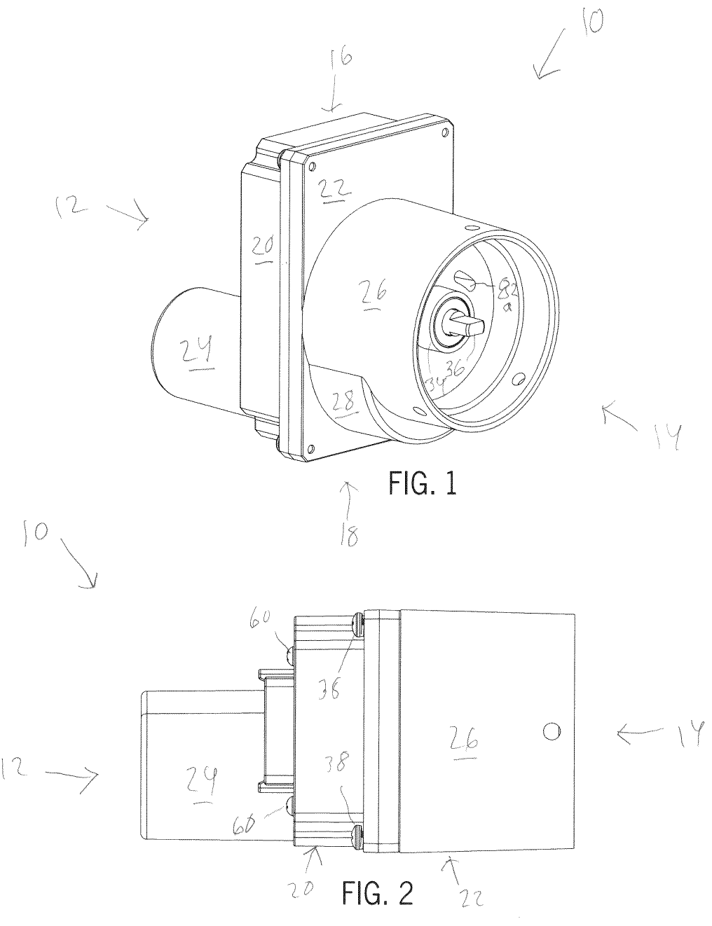

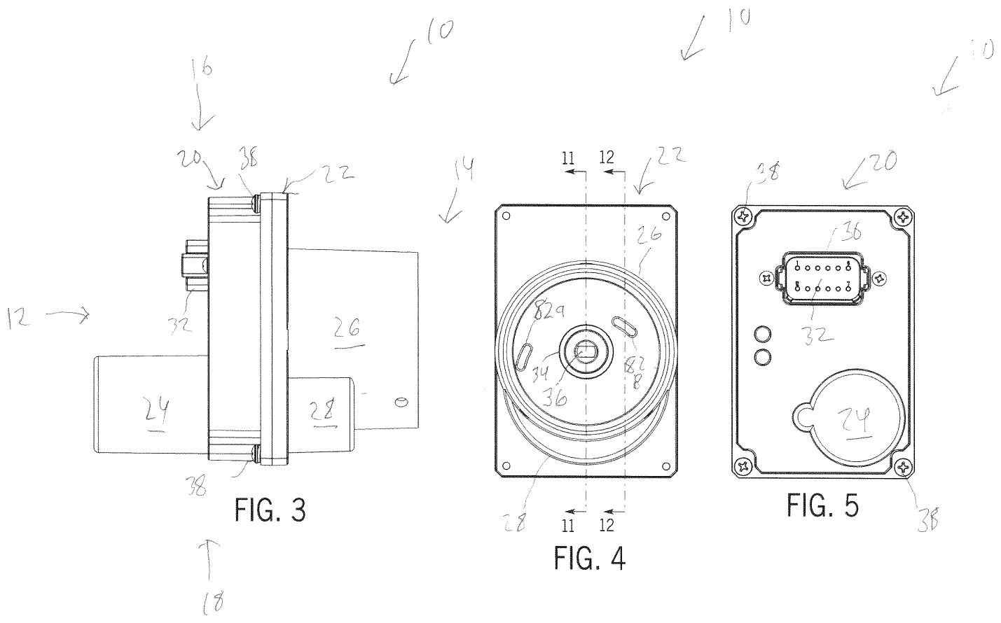

FIGS. 1-5 show the exterior features and components of an embodiment of an actuator 10 of the present invention. The actuator 10 has a first or proximal end 12 and a second or distal end 14, and a top 16 and bottom 18. FIG. 1 shows the actuator 10 in perspective, from a side and the distal end 14. FIG. 2 shows the top 16 of the actuator 10. FIG. 4 show details of the distal end 14 and FIG. 5 shows details of the proximal end 12.

The actuator 10 is a rotary type actuator. The actuator 10 has a housing or case, which is preferably constructed in two parts, a proximal housing member 20 and a distal housing member 22, both of which have a generally rectangular construction. The members 20 and 22 are joined by fastener, for example threaded screws 38. When operatively connected, preferably including a seal 42 the members 20 and 22 form a cavity or enclosure 40 of a predetermined configuration and geometry. The proximal housing member 20 has a generally cylindrical extension 24 for enclosing (46) an internal motor assembly. An electrical connector 30/32 is also provided, via aperture 44, on the proximal housing member 20. The distal housing member has a generally cylindrical upper extension portion or member 26. A curvilinear lower extension portion or member 28 depends from the bottom of the upper portion 26. These extensions enclose internal transmission and control components of the actuator 10. An output drive member, in the form of a shaft 36 extends from the distal end housing member 22, centrally disposed relative to the top portion 26. The shaft 26 has a predetermined configuration to mate with a complementary connector of an article, device, or apparatus which is intended by the user to be actuated. A cylindrical flange member 34 surrounds the rotatable shaft 36. A pair of curvilinear apertures 82A and 82B are disposed about the shaft 26.

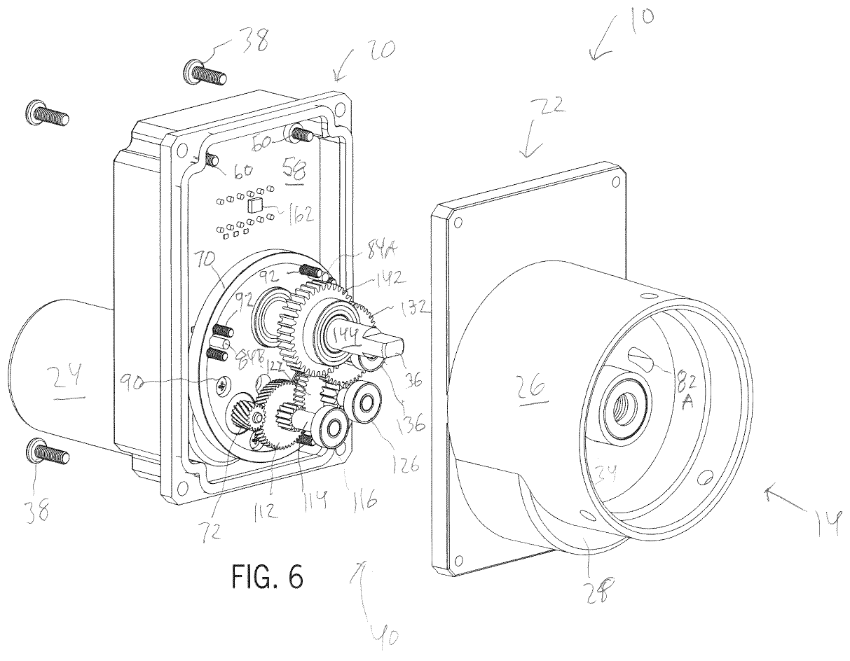

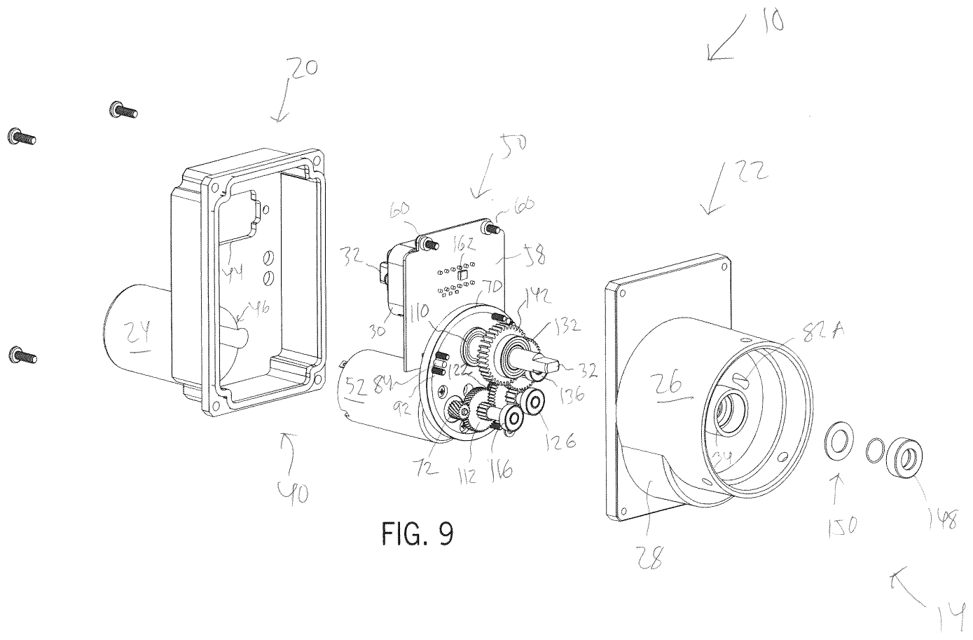

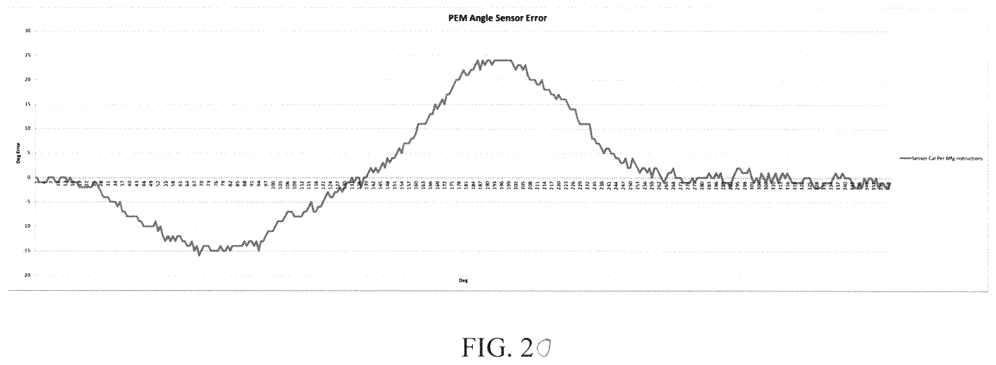

FIGS. 6-9 show the arrangement of interior features and components of actuator 10 disposed within the housing interior 40. In one embodiment, the components form an actuator assembly 50 comprising a motor assembly or motor 50, a transmission 52 and power and control electronic elements 58 which are preferably constructed on a Printed Circuit Board (PCB). Board 58 is held in place by fasteners 60. In the preferred embodiment of the rotary actuator 10 of the motor 52 provides rotary power to the connected rotary transmission 56 to ultimately rotate the output shaft 36. A sensor 160 in communicatively connected to an output shaft. Electronics 58 is communicatively connected to monitor sensor 160 position and output a simulated optical encoder response (U/V/W). FIG. 19 is a diagram showing a simulated optical encoder response. A home pulse is added, that is easily programmable to any angle. This can be used by the user to set a home position of the actuator 10 to the end assembly, aligning command position to output response.

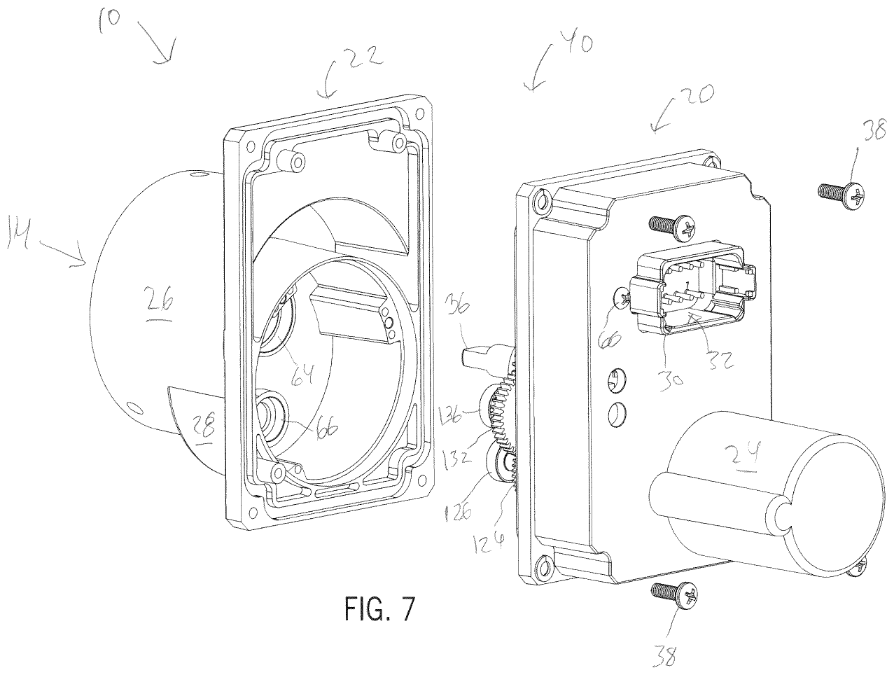

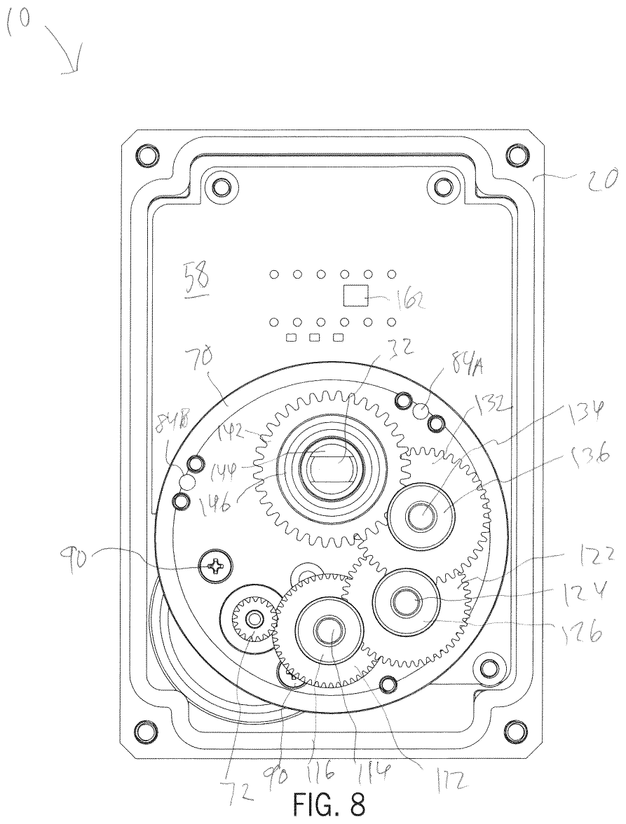

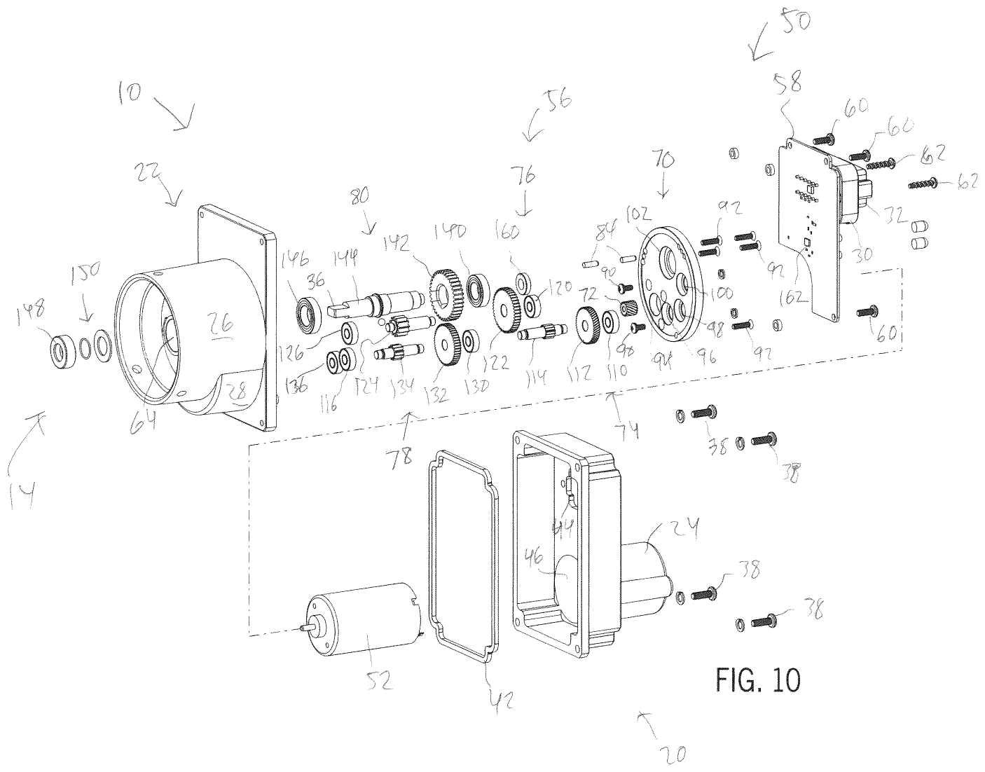

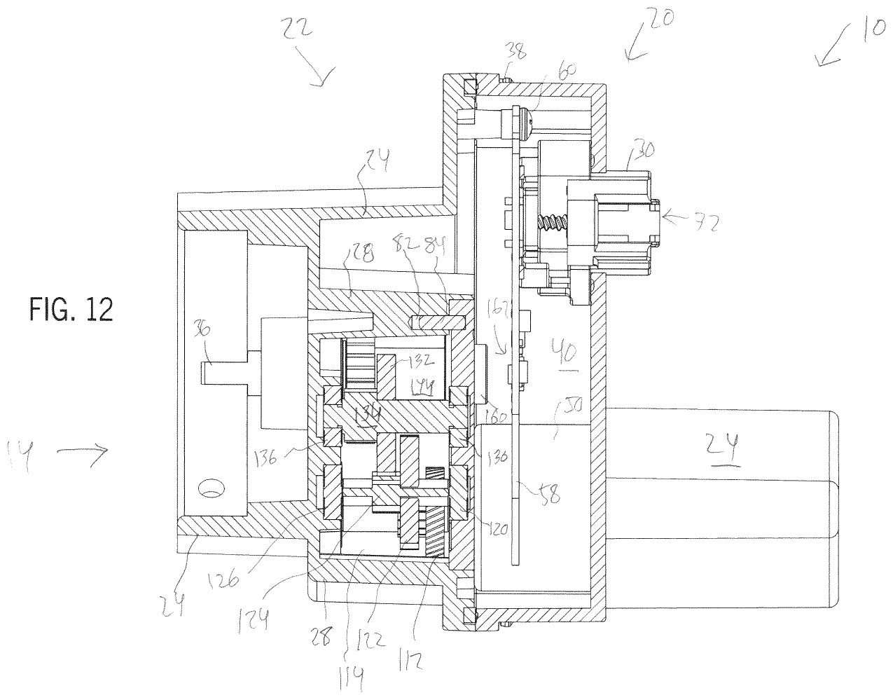

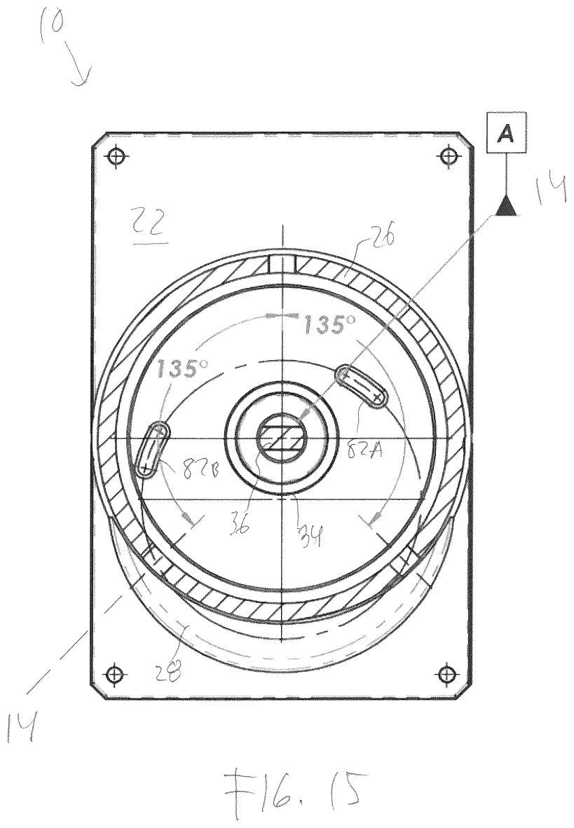

Turning to FIGS. 10 and 14, the motor 52, for example a 12 volt DC motor, is arranged longitudinally in a lower position in the housing 40. The distal output shaft of the motor 52 is coupled to a rotary gear 72. The transmission 56 is connected to the gear 72. In one embodiment, the transmission 56 comprises a gear box board 70 and three (3) stages. The board 70 is rigid and has cylindrical, disk shape. It is secured proximally by fasteners 90 and distally by fasteners 92 Dowel pins 84 extend from apertures in the board 70 to mating apertures in the distal housing. The stages include a first stage 74 connected to the motor gear 72, a second stage 76 connected to the first stage 74, and a third stage 78 which is connected to the second stage 76. The third stage 78 is connected to an output stage 80 which includes the output shaft 46. The board 70 has circular apertures 94, 96, 98, 100 and 102 which couple with bearings of the gear stages 74, 76, 78, and 80 to hold and stabilize the stages. Motor gear 72 extends through board aperture 94 The first stage 74 has a proximal bearing 110 (which mates with board aperture 96, a main or major gear 112 (which mates with motor gear 72), a shaft assembly 114 and a distal bearing 116. The second stage 76 has a proximal bearing 120 which mates with board aperture 98, a main gear 122 which mates with the first gear 112, a shaft assembly 124, and a distal bearing 126. The third stage 78 has a proximal bearing 130 which mates with board aperture 100, a main gear 132 which mates with the second gear 122, a shaft assembly 134, and a distal bearing 136. The output stage 80 has a proximal bearing 140 which mates with board aperture 102, a main gear 144 which mates with the third gear 132, a shaft assembly 144, and a distal bearing 146. Each shaft assembly 114, 124, and 134 is shown to have a minor gear member for connection to it's distal neighboring gear (122, 132 and 144, respectively) Referring to FIGS. 7, 11 and 12, the proximal bearings 114, 126, 136 and 146 couple with flanges disposed on the interior side of the distal end of distal housing member 22. Significantly, the proximal end of the shaft assembly 144 extends proximally through the proximal bearing 140 to the proximal side of board 70 where it connects with magnetic sensor 160. Sensor 160 is disposed near, but does not contact, a complementary reader 162 disposed on circuit board 58. At the distal end, drive shaft 144 extends though central distal aperture 64 so that distal end 36 is available for connection to an article, device, or apparatus to be actuated. A washer and O-ring pair 150 is disposed at aperture 64, as is a distal sealing member 148.

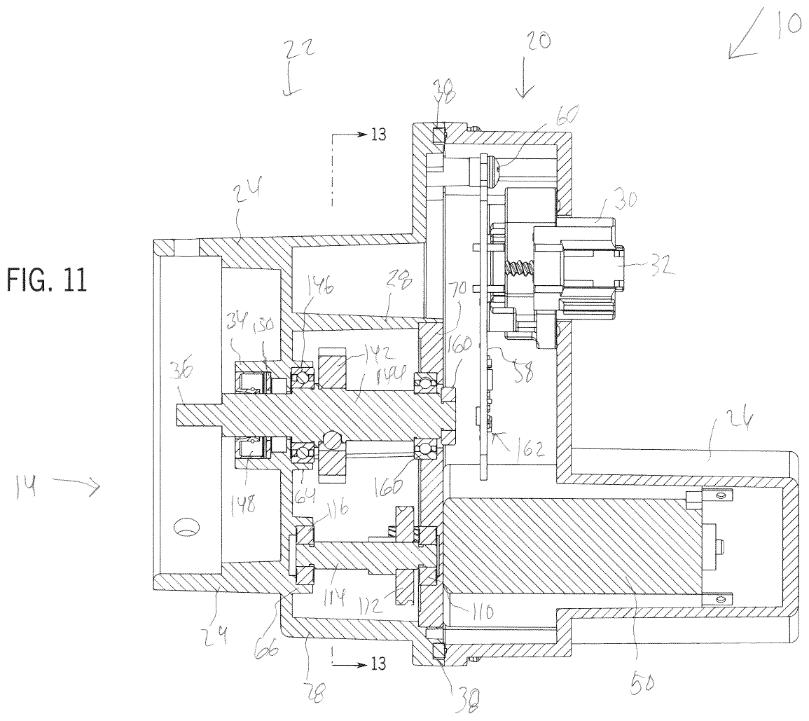

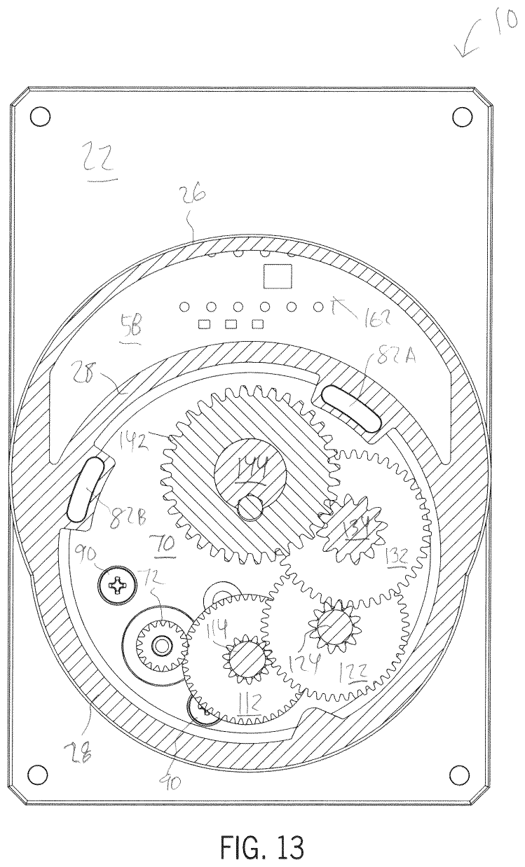

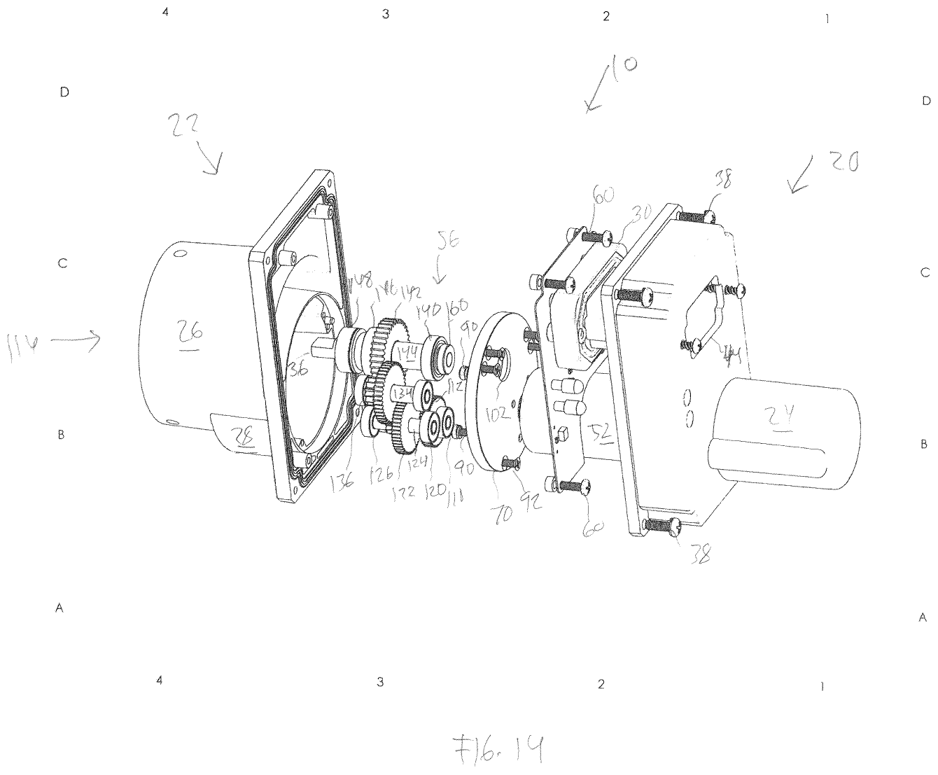

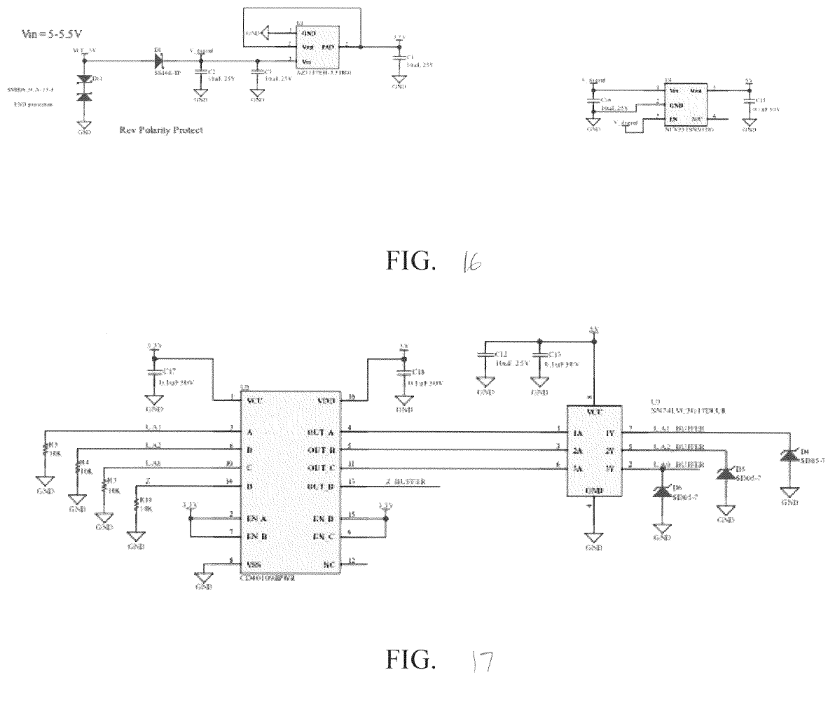

FIGS. 11-13 and 15 are cross-sectional views of the actuator 10 which show details of the structure, arrangement and geometries of the actuator assembly 50 disposed and interconnected with the housing interior structures and features.

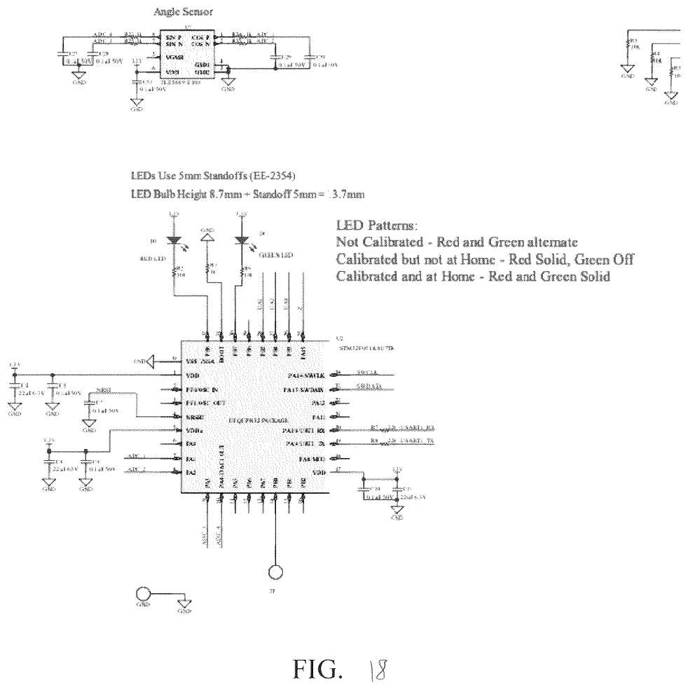

FIG. 16 is a schematic diagram of an embodiment of a power supply circuit of the invention. The power supply is capable of running on 5V.

FIG. 17 is a schematic diagram of an embodiment of an encoder circuit of the invention. The output is capable of sending U/V/W (U1, U2 & U3) encoder output.

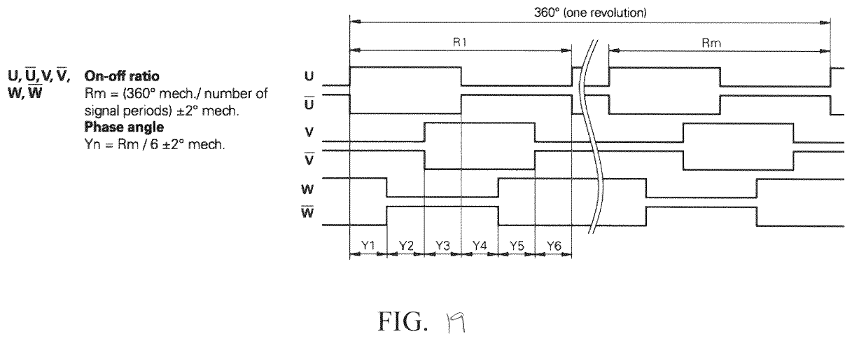

FIG. 18 is a schematic diagram of an embodiment of angle sensor and circuit for measuring shaft angle and saving calibration.

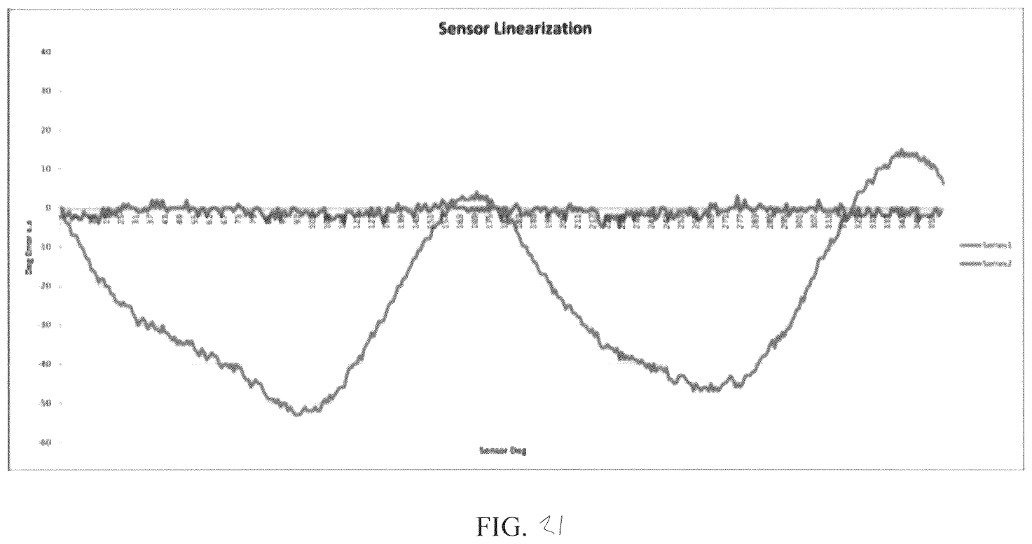

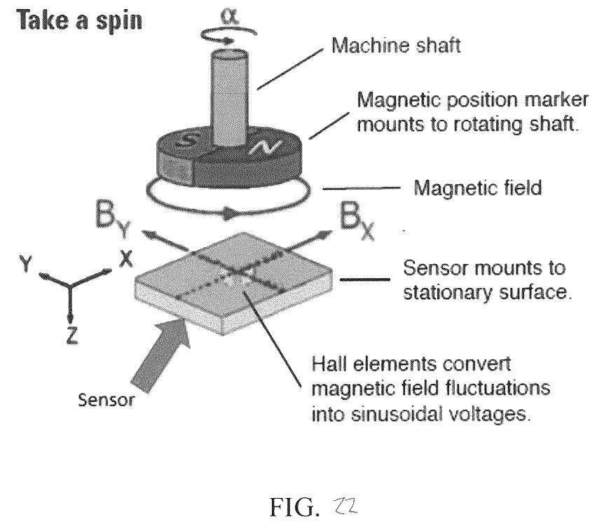

FIG. 20 is a graph showing angle sensor error, where the X axis is Degrees and the Y axis is Degrees Error. To emulate an optical encoder with 2000 counts, applicant would require 0.2 degrees accuracy. However, sensors tested by applicant had an error of up to +/−4 degrees.

FIG. 21 is a graph showing sensor linearization, where the X axis is Degrees Error and the Y axis is Sensor Degrees. Regarding sensor linearity after calibration, applicant assembled a fixture using a stepper motor to turn the drive shaft or the proposed actuator and the shaft position sensor. This calibration was then saved internally to the electronics. In doing this, applicant was able to “linearize” position accuracy from +/−4 degrees to +/−0.1 degree

Regarding sensor stability after calibration, applicant assembled the subject sensor and ran the shaft to random positions from 0-359.9 degrees. Applicant then varied the temperature from −30-105 C. In this range, applicant observed position stability.

The invention provides a fully sealed, long life, rotary actuator with a programmable encoder output for home position and number of pulses per 360 degrees rotation. The actuator has a preferred maximum limit of pulses of 3200. The user programs this to run as 2000 pulses per 360 degree rotation. This allows the user to install the actuator in their application with no external controller changes. The actuator is particularly useful for food industry applications to function with a long life, at high temperatures, with sealed product to run rotary valves.

The invention provides an emulated optical encoder using a noncontact magnetic sensor to measure output position with calibration to improve accuracy and electronics to simulate encoder outputs used to measure rotary position of a shaft.

Although the apparatus/method has been described in connection with the field of electro-mechanical actuators, it can readily be appreciated that it is not limited solely to such field, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments. “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed:

1. An actuator, comprising
a base;
a motor coupled to the base;
a transmission communicatively connected to the motor to transmit rotary power from the motor;
an output shaft communicatively connected to the transmission, the output shaft being adapted or configured to be connected to an article or apparatus to be actuated; and
a magnetic, non-contact sensor communicatively connected to the output shaft whereby the sensor measures output shaft position with calibration.

2. The actuator of claim 1, wherein the base is a housing having an internal enclosure, and wherein the motor, transmission, output shaft, and sensor are disposed in the enclosure.

3. The actuator of claim 2, wherein the housing has at least two, connectible and separable parts.

4. The actuator of claim 1, wherein the motor is an electric DC motor.

5. The actuator of claim 4, wherein the motor is a stepper motor.

6. The actuator of claim 1, wherein:
the motor has an output shaft with a rotary motor gear connected to the output shaft,
the transmission has at least one gear stage including a shaft assembly and a gear connected to the shaft assembly; the gear being communicatively connected to the motor gear; and
the output shaft includes an output gear communicatively connected to the gear stage gear.

7. The actuator of claim 6, wherein each shaft assembly has first and second ends, and wherein the first and second ends are rotatably supported by first and second bearings disposed at the respective first and second ends.

8. The actuator of claim 7, wherein there are at least two gear stages.

9. The actuator of claim 8, wherein there at three gear stages.

10. The actuator of claim 7, wherein the transmission further has a support board, the support board holding the first bearings of each shaft assembly in a fixed position.

11. The actuator of claim 10, wherein the second bearings of each shaft assembly are held in a fixed position by the base.

12. The actuator of claim 1, further comprising an electronic reader for reading the rotary position of the magnetic sensor.

13. The actuator of claim 12, wherein the magnetic sensor and emulate the response of an optical encoder.

14. The actuator of claim 13, further comprising electronic circuitry to emulate the response of an optical encoder.

15. The actuator of claim 14, wherein output shaft has a proximal end and a distal end, the distal end being adapted or configured to be connected to an article or apparatus to be actuated, and wherein the magnetic sensor is connected near the proximal end of the output shaft.

16. The actuator of claim 1 wherein:
i. the base is a housing having an internal enclosure, and wherein the motor, transmission, output shaft, and sensor are disposed in the enclosure
ii. the motor has an output shaft with a rotary motor gear connected to the output shaft,
iii. the transmission has at least one gear stage including a shaft assembly and a gear connected to the shaft assembly; the gear being communicatively connected to the motor gear; and
iv. the output shaft includes an output gear communicatively connected to the gear stage gear.

18. The actuator of claim 16:
i. further comprising an electronic reader for reading the rotary position of the magnetic sensor;
ii, wherein the magnetic sensor and emulate the response of an optical encoder; and
iii. further comprising electronic circuitry to emulate the response of an optical encoder.

19. An actuator, comprising
aa housing;
a motor coupled to the housing;
a transmission communicatively connected to the motor to transmit rotary power from the motor;
an output shaft communicatively connected to the transmission, the output shaft being adapted to be connected to an article to be actuated;
a magnetic, non-contact sensor communicatively connected to the output shaft whereby the sensor measures output shaft position with calibration; and
a control circuit communicatively connected to the sensor to simulate encoder output to measure rotary shaft position.

20. An actuator, comprising
a. a housing having an internal enclosure;
b. an electric DC stepper motor coupled to and disposed in the housing, the motor having an output shaft with a rotary motor gear connected to the output shaft;
c. a transmission communicatively connected to the motor to transmit rotary power from the motor, the transmission having at least one gear stage including a shaft assembly and a gear connected to the shaft assembly; the gear being communicatively connected to the motor gear;
d. an output shaft communicatively connected to the transmission, the output shaft being adapted to be connected to an article to be actuated, the output shaft including an output gear communicatively connected to the at least one gear stage gear;
e. a magnetic, non-contact sensor communicatively connected to the output shaft whereby the sensor measures output shaft position with calibration; and
f. a control circuit communicatively connected to the sensor to simulate encoder output to measure rotary shaft position.
